(19) United States
(12) Patent Application Publication
(10) Pub. No.: US 2026/0281045 A1
(43) Pub. Date: Sep. 17, 2026

(54) METHOD AND APPARATUS FOR MAPPING THREADS OF A UNIDIRECTIONAL PACKET SEQUENCE FLOW IN SDWAN

(71) Applicant: Versa Networks, Inc., Santa Clara, CA (US)

(72) Inventors: Fidelis Prashanth, San Jose, CA (US); Jayakrishnan Iyer, Morgan Hill, CA (US); Apurva Mehta, Cupertino, CA (US)

(21) Appl. No.: 19/081,698

(22) Filed: Mar. 17, 2025

(51) Int. Cl. H04L 47/2483; H04L 9/40; H04L 45/74; H04L 47/34

(52) U.S. Cl. CPC H04L 47/2483; H04L 45/74; H04L 47/34; H04L 63/029; H04L 2212/00

(57) ABSTRACT

Mapping threads is described for a unidirectional packet sequence flow in an SDWAN. A method includes receiving a first set of packets of a sequence of packets with a first flow identifier, saving the first flow identifier and routing the first set of packets to the destination address, assigning a second flow identifier to the sequence of packets, detecting thread punts for the first set of packets, sending an out-of-band message to the first hub from the second hub that includes the first flow identifier and a thread identifier for the sequence of packets in response to detecting the thread punts, receiving a second set of packets of the sequence of packets with the first flow identifier and the thread identifier from the first hub, and routing the second set of packets to the destination address using the thread identifier.

### TECHNICAL FIELD

The description relates to secure tunnel packet communication and, more particularly, to mapping threads for a unidirectional packet sequence flow sent through such secure tunnel packet communication.

### BACKGROUND

An overlay environment allows edge nodes to route packets to other edge nodes through a wide area network (WAN). The overlay environment is built on top of an existing network infrastructure whether a public infrastructure like the Internet or a private network. A Software-Defined Wide Area Network (SD-WAN) can be used to provide secure connectivity between multiple branches over multiple different discrete network transports such as Multi-Protocol Label Switching (MPLS), broadband, Long Term Evolution (LTE), satellite links etc.

To improve security and simplify access, a hub, which may be an edge node, gateway, gateway server, gateway router, switch, or virtual private network (VPN) server, may be used between the client and a remote hub to a destination client, service, or server. The hub is typically a server that brokers data transactions through a secure tunnel. A variety of tunneling protocols are available for the connection between a pair of hubs. These protocols include an Internet Protocol Security (IPsec) protocol, a Transport Layer Security (TLS) protocol, and a Datagram Transport Layer Security (DTLS) protocol, among others.

With the tunnel, the packets between one hub and another hub are encrypted and encapsulated in a wrapper. A packet from a client becomes an inner packet that is encapsulated within an outer packet that is the wrapper. The wrapper is handled as its own packet sent from the sending hub to the receiving hub with its own 5-tuple and encrypted contents. A typical 5-tuple is a packet header that includes a source Internet Protocol (IP) address (src-ip or SIP), a Destination Internet Protocol address (dst-ip or DIP), a protocol (proto), a source port (src-port) and a destination port (dst-port) and may be designated using the notation <src-ip, dst-ip, proto, src-port, dst-port>.

When a hub receives a packet from a local client to send through the tunnel, the packet will be addressed to another client, service, or server coupled to a second hub. The hub encapsulates the received packet as an inner packet within a wrapper and forwards the encapsulated packet to the second hub as appropriate based on the outer wrapper. Similarly, when a hub receives a packet through the tunnel, with an outer wrapper which is addressed to the hub, then the hub decapsulates the outer packet and forwards the inner packet to the appropriate client as indicated by the destination IP address of the inner packet. The hub may use a different tunnel or other security system to protect the contents of the inner decapsulated packet on the path to the client.

Network data communications may rely on virtualized resources to carry the data. A VNF (Virtual Network Function) may take the place of a hardware router. A Software-Defined Wide Area Network (SD-WAN) may take the place of a dedicated physical network. An SD-WAN may be configured to connect one or more end nodes, end users, and local area networks (LANs) to a branch. At least one designated hub is connected to each of the branches. The hubs are able to act as gateways to a plurality of branches. The branches themselves may have direct access to the Internet through one or more wide area network (WAN) links as well as through the hubs.

### SUMMARY

Embodiments herein relate to mapping threads of a unidirectional packet flow in an SDWAN. Embodiments herein disclose a method that includes receiving from a first node at a first hub a sequence of packets of a same flow, the sequence of packets having a destination address, facilitating a secure tunnel between the first hub and a second hub through a Software-Defined Wide Area Network (SDWAN), assigning a flow identifier to the sequence of packets having the destination address, sending a first set of packets of the sequence of packets with the flow identifier to the second hub through the secure tunnel, receiving an out-of-band message from the second hub that includes the flow identifier and a thread identifier for the sequence of packets in response to the second hub detecting thread punts for the first set of packets, and sending a second set of packets of the sequence of packets to the second hub with the flow identifier and the thread identifier.

In some embodiments, the out-of-band message comprises the thread identifier and a second hub identifier. In some embodiments, the out-of-band message is an Internet Control Message Protocol (ICMP) message. In some embodiments, receiving the out-of-band message comprises receiving the out-of-band message through the secure tunnel. In some embodiments, receiving the out-of-band message comprises receiving the out-of-band message through a control plane of the SDWAN.

Some embodiments include creating a session with the secure tunnel for the sequence of packets and updating the secure tunnel with the thread identifier after receiving the out-of-band message. Some embodiments include encapsulating the packets of the sequence of packets in a wrapper that includes the flow identifier.

In some embodiments, sending the sequence of packets comprises reducing a header of subsequent packets of the sequence of packets by removing fields from the header of the subsequent packets to form reduced packets. In some embodiments, removing fields comprises removing fields that are the same in the sequence of packets. Some embodiments include encapsulating a start packet of the first set of packets of the sequence of packets in a wrapper that includes the flow identifier, the header of the encapsulated start packet including fields that are removed from the header of the subsequent packets, and sending the encapsulated start packet from the first hub to the second hub through the secure tunnel.

Embodiments herein disclose a method that includes receiving a first set of packets of a sequence of packets with a first flow identifier at a second hub from a first hub through a secure tunnel of a Software-Defined Wide Area Network (SDWAN), the sequence of packets having a destination address, saving the first flow identifier and routing the first set of packets to the destination address, assigning a second flow identifier to the sequence of packets, detecting thread punts for the first set of packets, sending an out-of-band message to the first hub from the second hub that includes the first flow identifier and a thread identifier for the sequence of packets in response to detecting the thread punts, receiving a second set of packets of the sequence of packets with the first flow identifier and the thread identifier from the first hub, and routing the second set of packets to the destination address using the thread identifier.

In some embodiments, the out-of-band message is an Internet Control Message Protocol (ICMP) message. In some embodiments, sending the out-of-band message comprises sending the out-of-band message through the secure tunnel. In some embodiments, sending the out-of-band message comprises sending the out-of-band message through a control plane of the SDWAN. Some embodiments include assigning the first set of packets to a service processing thread and associating the thread identifier with the service processing thread.

In some embodiments, detecting thread punts comprises detecting that a packet of the first set of packets has landed on a wrong thread; using the first flow identifier to look up the service processing thread; and directing the packet to the service processing thread. In some embodiments, detecting thread punts comprises detecting that a number of thread punts of the first set of packets exceeds a punt threshold. In some embodiments, sending the out-of-band message comprises repeating sending the out-of-band message until a packet of the second set of packets is received. In some embodiments, repeating sending the out-of-band message comprises sending the out-of-band message at non-deterministic intervals.

Embodiments herein disclose a non-transitory computer-readable storage medium containing program instructions, which when executed by the computer cause the computer to perform operations comprising receiving a first set of packets of a sequence of packets with a first flow identifier at a second hub from a first hub through a secure tunnel of a Software-Defined Wide Area Network (SDWAN), the sequence of packets having a destination address, saving the first flow identifier and routing the first set of packets to the destination address, assigning a second flow identifier to the sequence of packets, detecting thread punts for the first set of packets, sending an out-of-band message to the first hub from the second hub that includes the first flow identifier and a thread identifier for the sequence of packets in response to detecting the thread punts, receiving a second set of packets of the sequence of packets with the first flow identifier and the thread identifier from the first hub; and routing the second set of packets to the destination address using the thread identifier.

### BRIEF DESCRIPTION OF THE FIGURES

The embodiments herein will be better understood from the following detailed description with reference to the drawing figures, in which:

FIG. 1 is a sequence diagram of mapping threads from a first hub in a unidirectional packet sequence suitable for embodiments herein;

FIG. 2 is a diagram of an out-of-band message suitable for communication through a secure tunnel with a thread identifier suitable for embodiments herein;

FIG. 3 is a process flow diagram of mapping threads at a first hub using a flow identifier and a thread identifier suitable for embodiments herein;

FIG. 4 is a process flow diagram of mapping threads at a second hub using a flow identifier and a thread identifier suitable for embodiments herein;

FIG. 5 is a block diagram of a client in communication with a remote server through a secure tunnel with a flow identifier suitable for embodiments herein;

FIG. 6 is a diagram of an IPv4 header suitable for embodiments herein;

FIG. 7 is a diagram of a TCP header suitable for embodiments herein;

FIG. 8 is a diagram of a UDP header suitable for embodiments herein;

FIG. 9 is a diagram of an IPv6 header suitable for embodiments herein; and

FIG. 10 is a block diagram of an apparatus, such as a node, that communicates as a client, gateway, or remote server suitable for embodiments herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The embodiments herein are described in the context of secure tunnels between two hubs. This may be in a Virtual Private Network (VPN) or in another context. The hubs may be in the form of gateways, edge nodes, VNFs and other related components. The VPN may connect through any of a variety of different data network environments with different physical or virtual structures. These structures include virtual networks such as a Software Defined Wide Area Network (SD-WAN or SDWAN) where there is at least one designated hub that operates as a node for each of one or more clients or a network of clients, such as on a local area network (LAN). However, embodiments disclosed herein can be applied in non-software-defined WANs and for applications hosted within the network, e.g., within a LAN (Local Area Network).

SDWAN overlay technology is used to provide secure connectivity between multiple branches over discrete network transports such as Multi-Protocol Label Switching (MPLS), Broadband, Long Term Evolution (LTE), Satellite links etc. To offer secure connectivity over multiple underlay paths with features such as security, traffic steering, inline accurate loss measurement, Traffic Engineering (SDWAN-TE), Forward Error Correction (FEC), etc. An SDWAN node manages multiple service-processing engines or threads. Each service-processing thread is identified by a thread identifier (tID). Each traffic flow is mapped to a designated thread. In some implementations, the thread-identifier is exchanged in an SDWAN header for bi-directional traffic, ensuring proper routing to the correct service-processing thread. However, unidirectional traffic lacks this exchange, causing thread punts and traffic degradation.

As described herein out-of-band signaling, e.g., Internet Control Message Protocol (ICMP) messages, may be used between hubs on either side of an SDWAN secure tunnel to correct flow misrouting. SDWAN efficiency may be improved by ensuring proper flow routing to the correct service-processing thread, reducing latency, minimizing thread punts.

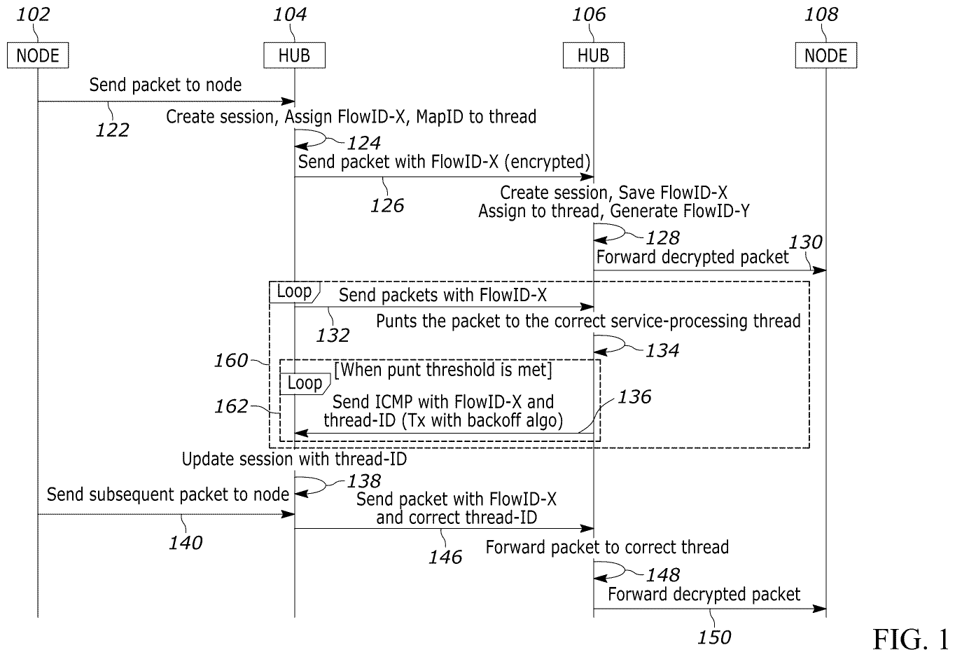

FIG. 1 is a sequence diagram of mapping threads from a first hub in a unidirectional packet sequence. A first node 102, e.g. a client, server, router, or other network node is coupled to a first hub 104. The first hub is coupled through an SDWAN to a second hub 106. The second hub is coupled to a second node 108. The nodes may be coupled to the hubs through a wide area network (WAN), a metropolitan area network (MAN), or a local area network (LAN) which may be the Internet or an intranet using any suitable physical transmission medium. The network may have many more nodes connected to the respective hub in any of a variety of different ways. There may be multiple hubs and multiple alternative routes. The hubs are connected to each other through any suitable physical or virtual network of an SDWAN. The SDWAN may include controllers coupled to the hubs through a control plane. The hubs may include or connect to other network appliances or functions for security, routing, transport and other functions.

The sequence diagram shows unidirectional traffic from the first node 102 to the second node 108. Unidirectional and bidirectional traffic use the same SDWAN headers. The SDWAN headers have a placeholder for a source thread identifier (tID) and a destination tID. For unidirectional traffic, the source tID is determined by the sending hub, included in the SDWAN header and will be accurate, however, the destination tID might be incorrect. In bidirectional traffic, the tIDs are synchronized between the two nodes. However, in unidirectional traffic, the tIDs are not synchronized as in bidirectional traffic. Unidirectional traffic through the SDWAN does not allow the thread identifier for each service processing thread to be sent in packets from the receiving hub 106 to the sending hub 104. This means that correct routing cannot be ensured by the normal exchange of packet traffic as when packets flow in both directions. At 122, the first node 102 sends a packet to the second node 108. This packet is a first packet or a start packet of a sequence of packets all of the same unidirectional flow. The packets may be determined to be of the same sequence as all sharing the same 5-tuple or by sharing a particular session with a service, or in another way. The packet includes a header and a payload. The header may include a 5-tuple or other routing data. The header includes a source address of the first node 102, acting as the source node, and a destination address of the second node 108, acting as the destination node. The packet sent at 122 is received at the first hub 104.

At 124, the first hub 104 creates a session and facilitates a secure tunnel to send the packet to the second hub. The first hub 104 maps the packet to a local service processing thread and assigns a flow identifier (flow ID) to the packet based on the 5-tuple or at least the source address and the destination address. The flow ID may contain information including an address of the first hub 104 that is sending the packet and an address of the second hub 106 to which the first hub 104 is sending the packet. Possible configurations and use of the flow ID are described in more detail below. The first node 104 facilitates a secure tunnel through the SDWAN to the second hub 106 and then at 126, the first hub 102 sends the packet through the secure tunnel to the second hub 106.

The second hub 106 receives the packet from the first hub 104 through the secure tunnel of the SDWAN at 126. At 128, the second hub 106 creates a session with the first hub 104, saves the first flow ID that was received with the packet and generates a second flow ID for the packet. The second hub also assigns the packet to a service processing thread and then saves a thread ID for that service processing thread with the first flow ID, the second flow ID, and the session information. The service processing thread is selected using a suitable quality of service and load balancing technique that is appropriate for the nature of the nodes and the packet. The second hub 106, then decapsulates the packet, decrypts the packet, reads the packet header and at 130 sends the packet to the second node 108 using the destination address of the packet header.

In this instance, the first hub 14 does not have the thread ID, and does not know where the thread is anchored. While the packet flow, so far having only one packet, is unidirectional, no flow anchor exchange will occur and so there will be no tID in subsequent packets. Subsequent packets from the first hub 104 will not have the tID assigned by the second hub and will not be identified with the selected service processing thread. As a result, one or more subsequent packets may land on the wrong thread. The second hub 106 may then be required to perform a lookup for the proper tID in its own state table and then punt the packet to the correct thread. Each of these thread punts require additional time and resources compared to when the tID is a part of the outer wrapper as when the tID is exchanged in two-way traffic.

At 132, the first hub 104 sends additional packets to the second hub 106. While these all include the first flow ID. The first hub does not have the tID and so these packets do not include the tID that was assigned to the flow. These packets are a first set of packets of the sequence of packets mentioned above. The packets of the first set of packets lack the tID from the second hub 106. The sequence of packets includes the packet of this single unidirectional flow from the first node 102 to the second node 108. At 134, the second hub punts each of the packets to the correct service processing thread. As above, in some examples, this may be done by applying the first flow ID received from the first hub 104 in the outer wrapper to a look up table at the second hub 106 to find the tID for the flow ID and corresponding packet. After each punt, the packet is forwarded to the second node 108.

At 136, after repeated thread punts by the second hub 106, the second hub detects that the number of thread punts of the first set of packets has exceeded a punt threshold. The second hub 106, then sends an out-of-band message to the first hub 103 that includes the first flow ID and the tID for the sequence of packets. The out-of-band message may include other information including a branch ID of the second hub 106, the second flow ID that was assigned by the second hub, etc. In some examples, the OOB message will contain the flow ID assigned by the first hub, the branch-id of the second-hub and the destination tID that indicates where the flow is anchored in the second node 108. A thread punt may be detected by detecting that a packet has landed on a wrong thread, by detecting that a look up has been performed for the tID at the second hub 106, and in other ways. Detecting the thread punts is a technique that may be used to determine that the sequence of packets is for a unidirectional flow. In the case of a two-way flow, there will be an exchange of the tID between the two hubs. The punt threshold may be selected as a number of punt detections after which the exchange would have taken place for a typical two-way flow.

The out-of-band message 136 is shown as being sent from the second hub 106 to the first hub 104 through the secure tunnel of the SDWAN. This allows the message to be sent when there is no reverse traffic or without waiting for reverse traffic. The message is an out-of-band message in that it is not attached to normal packet traffic. It is in the data plane through the secure tunnel. In some examples, the out-of-band message may be an ICMP message. In other examples, the out-of-band message is sent in a control plane of the SDWAN. This provides for a more secure delivery but requires additional overhead and may also require a use of a controller for the SDWAN. The message signals corrections from the second hub 106 to the first hub 104.

An ICMP message may be used or any other suitable error message. The ICMP message may include an error code and may indicate that the flow is unidirectional and there has been no tID exchange, or that the second hub did not find the tID in subsequent packets, or another error. The ICMP error message may have a specific flow ID error code and the flow id to indicate to the first hub 104 that the tID should be sent with each packet. The flow id may be included in the data section of the ICMP message. Alternatively, a different type of error message may be used. A unique flow id error code for the particular flow indicates to the first hub 104 that the problem affects the identified flow.

At 138, the first hub has received the out-of-band message. At 140, the first hub may update the session, or session state, for the sequence of packets through the secure tunnel with the tID that was received in the message from the second hub. The tID may be stored locally at the first hub 104 in association with the first flow ID and any other information regarding the sequence of packets.

At 140, the first hub 104 receives one or more subsequent packets from the first node 102. This is a second set of packets of the same sequence of packets. The second set of packets is after the first set of packets and after the first hub has received the tID. At 146, using the received tID, the first hub sends the second set of packets with the tID. The second set of packets are sent from the first hub 104 to the second hub 106 through the secure tunnel of the SDWAN. The secure tunnel is associated with the updated session. Accordingly, these packets are encapsulated within an outer wrapper. The tID may be in the outer wrapper with the first flow ID. Alternatively, the tID may be encapsulated within the outer wrapper.

At 148, the second hub 106 receives the second set of packets, reads the tID and at 148 forwards the packets to the correct thread based on the tID. With the tID included with the packet, especially in the outer wrapper, the packets may be quickly routed directly to the appropriate service processing thread. The packets are decapsulated, decrypted and at 150, sent to the second node 108.

The sequence diagram includes two loops. The first loop 160 represents a packet being sent with the first hub's flow ID but no tID at 132 and the second hub punting the thread at 134. These two steps may be repeated multiple times as a punt detection loop 160 until the punt threshold is reached. After the punt threshold is exceeded, then a second loop 162 is to send the out-of-band message at 136. Sending the out-of-band message is repeated until a packet of the second set of packets is received at 146. This packet includes the tID so that the second hub knows that the first hub has received the out-of-band message and has updated the session state.

The out-of-band message may be subjected to traffic and malicious attack. The repetition of sending the message may be performed at unpredictable intervals or non-deterministic intervals. This non-deterministic behavior reduces the risk of attacks, e.g., man-in-the-middle attacks. Any of a variety of different techniques may be used to determine a time to send a next out-of-band messages. In one example, an equation may be used to determine a random or pseudorandom number to determine a time to a next sending of the out-of-band message.

Equation 1 is an example of an equation of when to send the next out-of-band message. The time interval, I, to wait before the next message retry is given by

$$I = c \hat{} ( 2 \hat{} n ) + ε \qquad Eq . 1$$

where c is a constant, e.g. a number of baseline packets, n is a number of retries, e.g. how many times the out-of-band message has been sent, and ε is a randomizer.

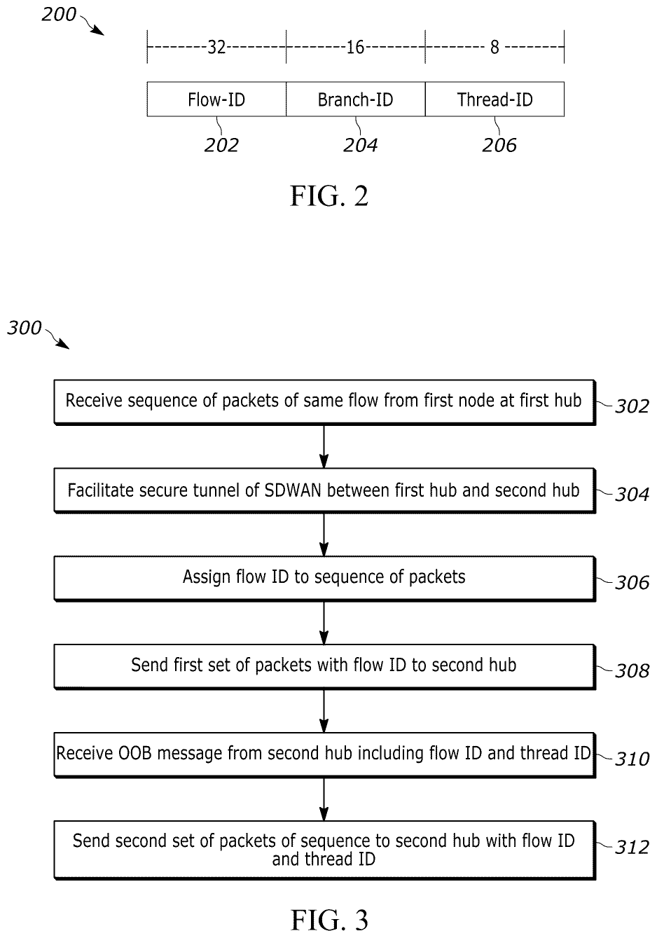

FIG. 2 is an example of the out-of-band message. The message 200 may be used as the message that is sent at 136 to provide the tID from the second hub 106 to the first hub 104. The message may be presented in an ICMP format or in any other format as determined by the nature of the out-of-band communications supported by the SDWAN. The message 200 includes the flow ID 202 that was assigned by the first hub 104 and included in the packets of the first set that were received by the second hub 106. The message includes a branch ID 204 to identify the second hub 106 as the sender of the message. The message includes the tID 206 assigned by the second hub 106 that the second hub 106 uses to route packets to the correct service processing thread.

The information in the message allows the first hub 104 to associate the tID 206 with the flow ID 202. Subsequent packets of the same flow will have the flow ID 202 and be sent to the second hub 106 using the branch ID 204 in a message that includes the tID 206 in the message.

FIG. 3 is a process flow diagram of mapping threads at the first hub 104 as described above in the context of FIG. 1. At 302, the first hub receives from a first node at a first hub a sequence of packets of a same flow, the sequence of packets having a destination address. The sequence of packets is from a node, e.g., node 102 that is coupled to the hub 104 through a local or remote connection. At 304, the first hub facilitates a secure tunnel between the first hub and a second hub through a Software-Defined Wide Area Network (SDWAN). The secure tunnel may be established for this packet sequence after receiving one or more packets of the packet sequence or the secure tunnel may be established before receiving any packets of this flow. The flow may be defined as packets that have the same 5-tuple in a header, or in a different way. The destination address and a source address for the node 102 may be identified using the 5-tuple or in another way. A session may be created with the secure tunnel for the sequence of packets.

At 306, the first hub assigns a flow ID to the sequence of packets having the destination address. The flow ID may be assigned in part to packets with the same destination address or dst-ip. At 308, the first hub sends a first set of packets of the sequence of packets with the flow identifier to the second hub through the secure tunnel. The first set of packets includes at least a first packet or a start packet and may include additional packets.

At 310, the first hub receives an out-of-band (OOB) message from the second hub that includes the flow ID and a tID for the sequence of packets in response to the second hub detecting thread punts for the first set of packets. The flow ID is the flow ID that was sent by the first hub. This allows the first hub to quickly identify the sequence of packets. The tID relates to a service processing thread that has been determined by the second hub. The tID is particularly useful for the second hub is routing packets in the sequence to the selected service processing hub. The OOB message may be an ICMP message. The OOB message may be received through the same secure tunnel or through a control plane of the SDWAN. The control plane may or may not include a controller of the SDWAN. After receiving the tID in the OOB message, the first hub may update the secure tunnel with the tID and update the session.

At 312, the first hub sends a second set of packets of the sequence of packets to the second hub with the flow ID and the tID. The second set of packets is sent after the first set of packets and after receiving the tID. The first and second set of packets may be the same or different in kind and quantity, depending on when the OOB message with the tID is received. In sending the second set of packets, the packets of the sequence of packets are encapsulated in a wrapper that includes the flow id. In some examples, the flow id may be used to reduce the outer header or wrapper of subsequent packets after sending a start packet. The header of subsequent packets may be reduced by removing fields from the header of the subsequent packets to form reduced packets. The removed fields may be fields that are the same in the sequence of packets. In this example the operation of sending the second set of packets includes encapsulating a start packet of the first set of packets of the sequence of packets in a wrapper that includes the flow identifier. The header of the encapsulated start packet includes fields that are removed from the header of the subsequent packets. The encapsulated start packet is sent from the first hub to the second hub through the secure tunnel. The subsequent packets may be reduced packets.

In some examples, there is no acknowledgment from the first hub that the OOB message has been received. The first packet of the second set of packets with the tID operates as an acknowledgment. In some examples the second hub will repeat sending the OOB message with the tID until it receives a packet with the tID included. The second hub is able to determine if the received packet with the tID is from the same flow using the flow ID that is included with the packets. In some examples the second hub will repeat sending the OOB message with the tID until it receives an explicit acknowledgment of the OOB message.

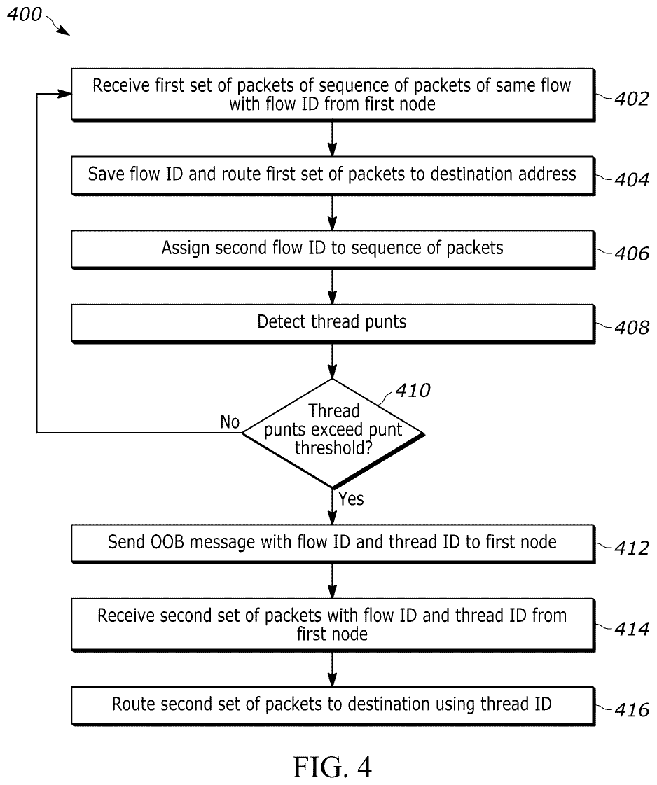

FIG. 4 is a process flow diagram of mapping threads at the second hub 106 as described above in the context of FIG. 1. At 402, the second hub receives a first set of packets of a sequence of packets with a first flow identifier from the first hub through a secure tunnel of the SDWAN. The packets of the sequence have a destination address, e.g. as a part of the outer wrapper of the received packet to aid in routing.

At 404, the second hub saves the first flow identifier that was included with the first packet or the start packet of the first set of packets and then routes the first set of packets to the destination address. At 406, the second hub assigs a second flow identifier to the sequence of packets. The second flow identifier may be saved in association with the first flow id.

As the packets in the first set of packets continue to arrive, the second hub has determined a service processing thread for the flow. The second hub may assign the first set of packets to the service processing flow and associate a tID with the service processing thread. With subsequent packets, there may be thread punts as the packets are forwarded to the selected service processing thread. The second hub detects these thread punts for the first set of packets. The thread punts may be detected by detecting that a packet of the first set of packets has landed on a wrong thread, using the first flow identifier to look up the service processing thread, and then directing the packet to the service processing thread.

The thread punts are detected and the number of thread punts is compared to a punt threshold at 410. If the thread punts do not exceed the punt threshold, then the second hub continues routing packets of the first set of packets as they arrive. When at 410, the thread punts exceed the punt threshold, then the second hub at 412 sends an OOB message to the first hub from the second hub that includes the first flow ID and a tID for the sequence of packets.

After the first hub receives the OOB message it will include the tID in the second set of packets of the sequence of packets. The first hub sends packets that now include the tID with the first flow ID. At 414, the second hub receives a second set of packets of the sequence of packets with the first flow ID and the tID from the first hub. At 416 the second hub routes the second set of packets to the destination address using the thread identifier.

A packet may be punted to a next level thread processing service or to a different router processor when the hub is not able to perform the thread processing or to determine the appropriate thread processing at the hub. The packet may be punted for network address translation, policy-based routing or for other service processing. The punt rate may be monitored as the number or portion of packets that are punted compared to the total number of packets. The punt rate may also be monitored as the number of punts for a particular packet flow.

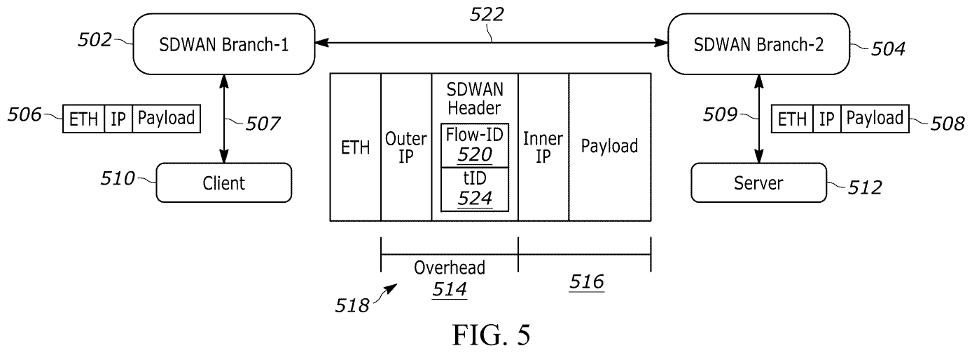

FIG. 5 is a block diagram of a client 510 in communication with a remote server 512 through a first branch node 502 of an SD-WAN and a second branch node 504 of the SD-WAN. In this example, the first branch node 502 operates as a first hub and the second branch node 504 operates as a second hub in the SD-WAN. The client 510 is coupled to the remote server 512 to receive connections and services hosted by the remote server 512. The same principles apply for communication between two servers or two clients instead of a client and a server.

The first branch node 502 is coupled to the client 510 through a network 507 such as a wide area network (WAN), a metropolitan area network (MAN), or a local area network (LAN) which may be the Internet or an intranet. The client 510 and the first branch node 502 communicate through the network 507 with packets in a form suitable for the protocols of the network 507. As shown, in some embodiments, a start packet 506 through the network 507 has a form of an Ethernet header, an IP header, e.g., a 5-tuple, and a payload. Similarly, the remote server 512 is coupled to the second branch node 504 through a network 509 of any suitable type to send and receive packets with the second branch node 504. The forwarded packet 508 to the server from the second branch node 504 may have a same or similar form as the start packet 506. As shown, the forwarded packet 508 has a same structure of Ethernet header, IP header, and payload as the start packet 506. However, this is not required. The client 510 and remote server 512 may be physical computing systems or virtualized resources in one or more distributed locations. For packets sent in the opposite direction, i.e., from the remote server 512 to the client 510, the packets will have the same form as the packets shown.

The client or the server or both may be a server, workstation, desktop computer, thin client, notebook computer, tablet, a point-of-sale device in any form, a mini-computer, a stick computer, cellular telephone, or any other communication device that connects to other networks through a wired or wireless network, for example Ethernet, Wi-Fi, or a cellular network. The client or the server may be physical or virtualized in any suitable way.

The first branch node 502 communicates packets between the client 510 and the second branch node 504. The client 510 may have one or more service applications to communicate with the remote servers 512, such as a web browser, email application, file transfer application, portal application, etc. The client 510 and the remote server 512 may also have a VPN application that is configured to configure and manage VPN sessions. The first branch node 502 communicates with the second branch node 504 using a secure tunnel 522, e.g., a VPN session or other secure session. The secure tunnel facilitates the use of a secure protocol for secure tunneling through what may be an insecure network. The techniques and structures described here may be used in a variety of different specific physical connections and IP protocols. Those described here are provided only as examples.

The first branch node 502 has a communications interface that enables data communications with authentication, secure tunnels, Service Level Agreement (SLA) metrics, route exchange, capability exchange, session establishment, etc. The capability exchange may be used to determine that the first branch node 502 and the second branch node 504 are able to communicate using a flow identifier and reduced packet header. The capability exchange may also be used to enable or disable the use of reduced packet headers or to select appropriate policies. The first branch node 502 may communicate with the second branch node 504 using any suitable secure tunneling protocol e.g., IPsec, TLS, or DTLS. A session may be established to secure credentials and protocols for the secure tunnel 522. Encapsulated packets 518 that are forwarded by the first branch node 502 or by the second branch node 504 are first encapsulated and then sent. The encapsulation places an inner packet 516 with an inner IP header and a payload within an outer wrapper 514 with an outer IP header and an SD-WAN header. For the start packet 506, the inner packet 516 is the same as the start packet 506 from the client 510 with the same IP header which is also the same as the forwarded packet 508 to the remote server 512. The outer IP header is added to the inner packet 516 to support the secure tunnel 522 and allows for the packet to be communicated between the first branch node 502 and the second branch node 504. In some examples, the inner packet 516 is compressed or encrypted or both to improve security through the secure tunnel.

The start packet 506 from the client 510 may be a start packet of a sequence of packets of a flow. For purposes of the present description, a flow refers to a communication channel between endpoints. In the example of FIG. 5, the endpoints are the client 510 and the remote server 512. In many examples, a flow is defined by its 5-tuple, a collection of five data points. However, this is not necessary in every implementation, e.g., the source and destination ports are not used in ICMP. In some examples, the protocol is not included in the packet headers because it is assumed or determined by a separate protocol. In addition, the path between the first branch node 502 and the second branch node 504 may change without affecting the flow that is between the two endpoints. Herein, a flow will generally be described as being defined by its 5-tuple, however, other flow definitions are also contemplated.

For the flow of FIG. 5, the client 510 is in communication with the remote server 512. This may be indicated by the 5-tuple from the client and the 5-tuple from the server, or in another way, so that each packet of the respective sequence of packets shares a same 5-tuple. The first branch node 502 may then assign a flow identifier to the sequence of packets from the client. The first branch node 502 may then include the flow identifier with the encapsulated packet 518 that is sent to the second branch node 504. The flow identifier may be used to identify the flow, that is the sequence of packets each having the 5-tuple. In some examples, the first branch node 502 includes the flow identifier 520 in the SD-WAN header of the outer wrapper 514. The flow identifier 520 identifies the sequence of packets but does not affect the addresses in the SD-WAN header so that intermediate nodes in the path from the first branch node 502 to the second branch node 504 are not affected by the flow identifier 520.

The second branch node 504 receives the flow identifier 520 and the intact start packet 506 as the inner packet 516 with the inner IP addresses and the payload of the encapsulated packet 518. The flow identifier 520 identifies the start packet 506 as a first packet in the sequence of packets. The second branch node parses the header (Inner IP) of the start packet 506 to route the forwarded packet 508 to the remote server 512. Upon reading the flow identifier 520, the second branch node also saves the parsed header of the start packet for use with the second and subsequent packets of the corresponding sequence of packets.

For a subsequent packet of the sequence of packets after the start packet from the same client to the same server, the first branch node 502 may also include a tID 524 in the SDWAN header. This may be with the outer IP or in another position of the outer wrapper indicated as overhead 514. The second branch node 504 is able to read the flow ID 520 and the tID 524 without decapsulating or decrypting the packet 518. The subsequent packet is sent using the same secure tunnel that was established for the first packet and which may include a secure session and any suitable secure tunneling protocol e.g., IPsec, TLS, or DTLS.

In some examples, the Ethernet and IP header of the second packet of the subsequent packets are converted into a reduced form, e.g. compressed or as metadata. The flow identifier 520 and tID 524 may be a part of an SDWAN header that is included in a metadata version of the overhead 514. Security may be improved because the metadata is not readily parsed by nodes on the path between the first branch node 502 and the second branch node 504.

An SD-WAN creates a tunnel that is transport-agnostic, application-aware, and supports centralized management and provisioning. An SD-WAN can be inserted into other types of networks and allow for gradual migration from the existing MPLS, dynamic multipoint VPN (DMVPN), and other networks to SD-WAN. Some form of a cookie, label, flow-id, or a (source-port, destination-port) pair, referred to as a flow identifier herein, is then associated with the flow. This cookie/label/flow-id/port-pair is communicated with the entire payload packet from an SD-WAN sender to an SD-WAN receiver at least once using a start packet. Once the remote receiver on each side has learned the mapping that is used by the sender and confirms that the mapping has been learned, then the sender encodes its flow identifier in the SDWAN-header and is able to skip provide consistent routing, service processing, and other services. In some examples some or all of the immutable fields of the inner packet in the traffic are not sent in subsequent packets.

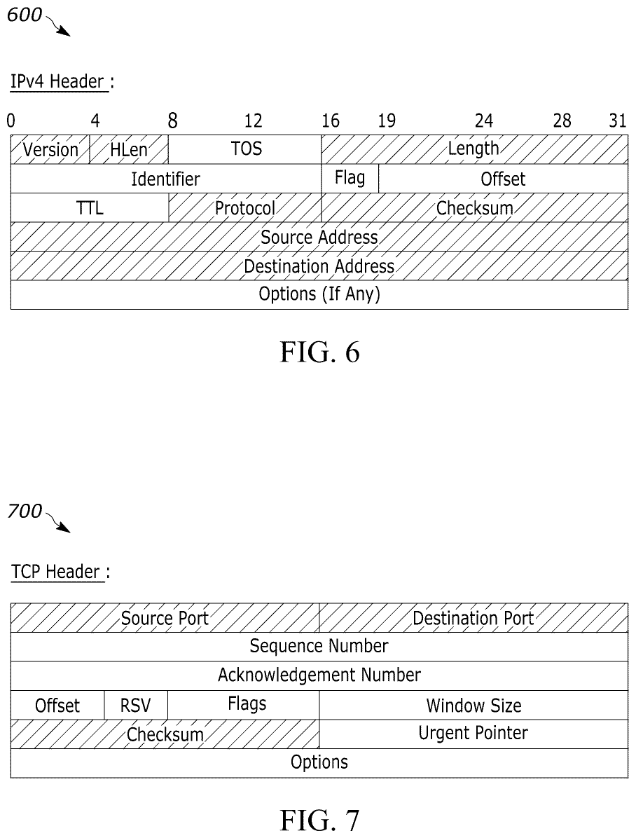

FIG. 6 is a diagram of an Internet Protocol version 4 (IPv4) header 600 showing an example of a division into mutable and immutable fields. The immutable fields are immutable for the duration of the 5-tuple and are shown as hashed. The labels of the fields and their characteristics may vary for different types of packets and different protocol variations. For the duration of the 5-tuple, the source address, destination address, and protocol fields do not change. The values for the version, Header Length (HLen), Length fields also do not change. The Checksum field will be recalculated by the receiving node. After the first packet with the IPv4 header, the values for these fields do not need to be sent again and the fields can be removed. By contrast, the values of the Type of Service (TOS), Identifier, Flag, Offset, and Time to Live (TTL) fields may change with each packet and are included in each packet. These values may be combined, compressed, and otherwise reduced in size. The reduced number of fields may be sent as is or converted into a metadata portion of an encapsulated packet.

FIG. 7 is a diagram of a Transmission Control Protocol (TCP) header 700 that may be included in an IP packet and showing a division into mutable and immutable (shaded) fields. For the duration of the 5-tuple, the source port and destination port do not change. The Checksum field will be recalculated by the receiving node. By contrast the values of the sequence number, acknowledgment number, offset, reserved (RSV), flags, window size, and urgent pointer fields may change with some new packets and are included in each new packet. As mentioned above, these values may be combined, compressed, and otherwise reduced in size. The reduced size values may be included in a metadata portion of an encapsulated packet.

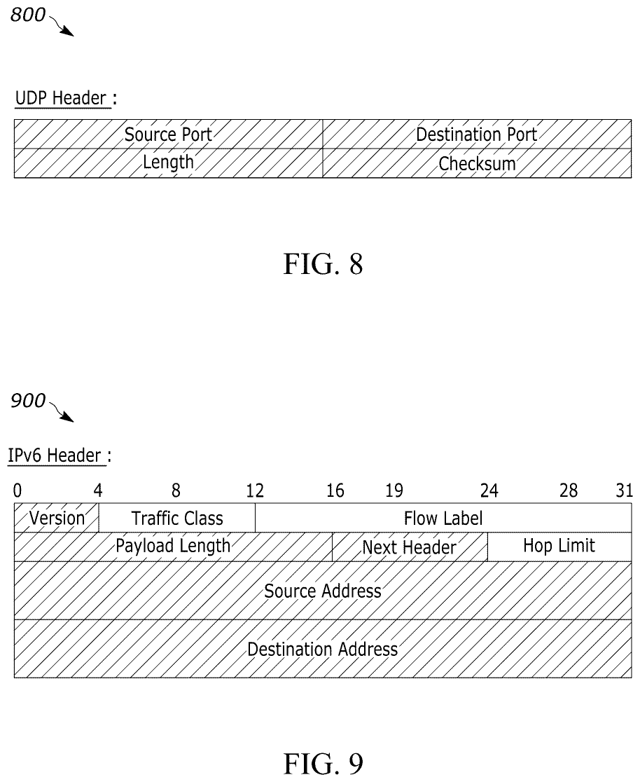

FIG. 8 is a diagram of a User Datagram Protocol (UDP) header 800 that may be included in an IP packet and showing a division into mutable and immutable (shaded) fields. In the UDP header, all of the fields, source port, destination port, and length, are immutable and may be removed after the first packet.

FIG. 9 is a diagram of an Internet Protocol version 6 (IPv6) header 900 showing a division into mutable and immutable fields. The immutable fields are immutable for the duration of the 5-tuple and are shown as shaded. For the duration of the 5-tuple, the source address, destination address, payload length, next header and version fields do not change. After a start packet with an IPv6 header, these fields do not need to be sent again and can be removed. By contrast, the traffic class, flow label, and hop limit fields may change with each packet and are included in each packet in some form and may be compressed and may be rendered as metadata.

The structures of the above headers are provided as examples. Principles herein may be applied to other variations of these headers with changes to their configurations and also to different headers that have different fields. The division of fields may also be changed so that some fields shown as immutable may be treated as mutable and some fields shown as mutable may be treated as immutable. The structures are shown as example to illustrate the principles herein.

The described approach using flow identifiers does not necessarily invalidate the use of sequence numbers or any particular sequence numbers of received packets, nor does it necessarily add any metadata to Transmission Control Protocol-Synchronize (TCP SYN) packets, which might not be acceptable to firewalls and transit devices. As a result, TCP packets do not have to be transformed into UDP packets, but may be sent through the SD-WAN as UDP packets. Network address traversal (NAT) devices and firewalls in the underlay transport networks are not affected by the use of the flow identifiers because the outer wrapper is not changed. Keep-alive packets are not required for individual user sessions because Network Address Traversal (NAT) sessions do not need to expire. The use of the flow identifier through a secure tunnel may be enabled or disabled at will between any two sites or nodes without affecting the session or the paths. In addition, using the SD-WAN header, the parameters of the reduced packets may be adjusted. This includes the level of compression, enabling and disabling the packet reduction mode, and using or choosing different policies.

In some embodiments a hub or other node may use a variant of Connectivity Fault Management/Y.1731 (CFM: IEEE 802.1ag) to monitor all the possible paths to other hubs with which the hub needs to communicate directly. For this purpose, a path is from the transport address on one hub to a transport address on another hub. The hub or other node may build a database of information about possible paths over various access circuits. The information may include latency, jitter, packet loss, and roundtrip delay to other SD-WAN sites.

The detail of the 5-tuples for the outer addresses and the inner addresses may be maintained in a memory at the hub, branch, or gateway. The 5-tuple details may be mapped to the corresponding tunnel session. This map may be maintained in a database in a memory of the hub.

The unidirectional traffic approach applied here with thread identifiers may be applied to any secure tunnel including to a virtual private network (VPN). In a typical VPN protocol, the client communicates through the VPN tunnel using the outer wrapper 5-tuple. When Network Address Translation (NAT) is used, the hub removes the client tunnel IP address and replaces it with a routable gateway IP address before forwarding the inner packet to the corresponding remote server using the destination IP address of the packet received from the client. The remote server responds to the routable gateway IP address and does not see the client IP address. The client does not see the routable gateway IP address except when the gateway uses the same address for the VPN session with the client.

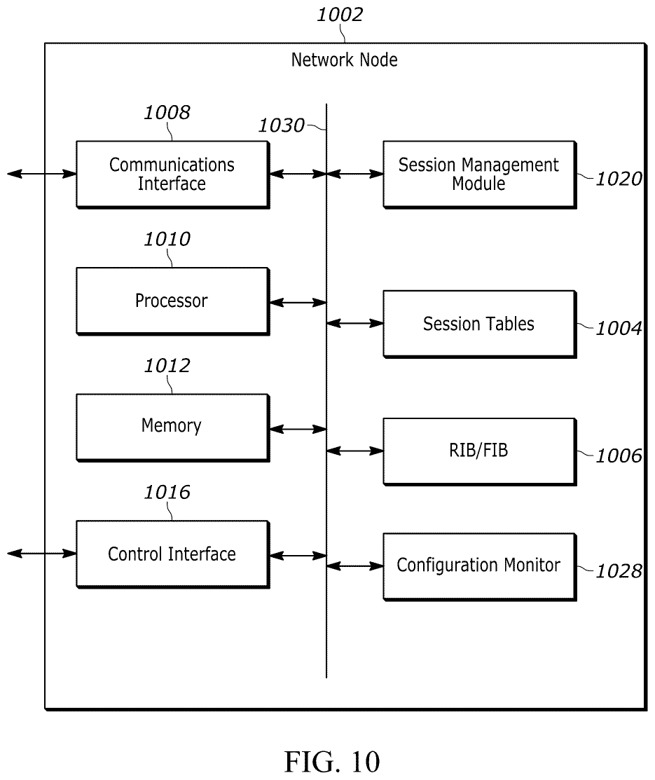

FIG. 10 is a block diagram of an apparatus, such as a node 1002 or hub that communicates as a client, hub, branch, gateway, or server as described herein. The node may be a gateway, a source branch, a destination branch, an edge node, or a hub node, or another network node according to embodiments herein. The node includes a communications interface 1008, a processor 1010, and a memory 1012 connected together through a bus 1030. The processor 1010 may include a multifunction processor and/or an application-specific processor. The memory 1012 within the node may include, volatile and non-volatile memory for example, a non-transitory storage medium such as read only memory (ROM), flash memory, Random Access Memory (RAM), and a large capacity permanent storage device such as a hard disk drive.

The communications interface 1008 enables data communications with authentication, secure tunnels, SLA metrics, route exchange, capability exchange, session establishment, etc., via local and wide area connections using one or more different protocols including Ethernet, IPsec, TLS, DTLS, Multiprotocol Border gateway Protocol (MP-BGP), Virtual LAN (VXLAN), MPLS, etc. The node 1002 executes computer readable instructions stored in the storage medium of the memory 1012 to implement various tasks as described herein. The node 1002 further includes a routing table manager with a Routing Information Base/Forwarding Information Base (RIB/FIB) 1006 and various other traffic caches (e.g., application cache, domain application cache, client route cache, and application route cache) to store mapping information and other traffic communication data coupled to the bus 1030. The computer in the form of the node 1002 executes computer readable instructions stored in the storage medium to implement various tasks as described above.

A control interface 1016 may be provided for node management and configuration purposes as an interface to a computer monitor or flat panel display but may include any output device. In addition, the control interface 1016 may include an interface to a computer keyboard and/or pointing device such as a computer mouse, computer track pad, touch screen, etc., that allows a user to provide inputs and receive outputs including a GUI (graphical user interface). A GUI can be responsive to user inputs and typically displays images and data. The control interface 1016 can be provided as a web page served via a communication to a remote device for display to a user and for receiving inputs from the user. Additionally, each of the modules may be implemented through instructions stored on a non-transitory computer-readable storage medium. The computer-readable instructions, e.g., program instructions, are executed on a physical processor of a computing system that supports the node to cause the computer to perform the operations described herein, among others.

The node 1002 includes a configuration monitor 1028 to monitor policy input including secure tunnel protocols, network interface state updates, and remote monitor updates, among others. The configuration monitor 1028 generates alerts or interrupts and updates backup status when there are changes to any of the monitored network node states, and configurations. The configuration monitor 1028 may also maintain a routing information base/forwarding information base (RIB/FIB) 1006.

The node further includes session tables 1004 and a session management module (SMM) 1020 to monitor any sessions that are established by the node or with the node through a secure tunnel, VPN, or other connection. The session tables may include session object states, flow identifiers, immutable field values, and other values. The session tables may be updated in response to error messages, flow identifiers from other hubs, and the start or end of a sequence of packets using the same 5-tuple. In embodiments, the session management module includes a secure tunnel or VPN client. Another session management module may be coupled to web clients that are operated by the processor 1010.

The embodiments disclosed herein can be implemented through at least one software program running on at least one hardware device and performing network communication functions to connect through secure tunnels and with remote servers.

It is understood that the scope of the protection for systems and methods disclosed herein is extended to such a program and in addition to a computer readable storage medium having a message therein, to such a computer readable storage medium containing program code means for implementation of one or more steps of the method, when the program runs on a server or mobile device or any suitable programmable device.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

While the above-described techniques are described in a general context, those skilled in the art will recognize that the above-described techniques may be implemented in software, hardware, firmware, or any combination thereof. The above-described embodiments of the invention may also be implemented, for example, by operating a computer system to execute a sequence of machine-readable instructions. The instructions may reside in various types of computer readable media. In this respect, another aspect of the present invention concerns a programmed product, comprising computer readable media tangibly embodying a program of machine-readable instructions executable by a digital data processor to perform the method in accordance with an embodiment of the present invention.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

What is claimed is:

1. A method comprising:
receiving from a first node at a first hub a sequence of packets of a same flow, the sequence of packets having a destination address;
facilitating a secure tunnel between the first hub and a second hub through a Software-Defined Wide Area Network (SDWAN);
assigning a flow identifier to the sequence of packets having the destination address;
sending a first set of packets of the sequence of packets with the flow identifier to the second hub through the secure tunnel;
receiving an out-of-band message from the second hub that includes the flow identifier and a thread identifier for the sequence of packets in response to the second hub detecting thread punts for the first set of packets; and
sending a second set of packets of the sequence of packets to the second hub with the flow identifier and the thread identifier.

2. The method of claim 1, wherein the out-of-band message comprises the thread identifier and a second hub identifier.

3. The method of claim 1, wherein the out-of-band message is an Internet Control Message Protocol (ICMP) message.

4. The method of claim 1, wherein receiving the out-of-band message comprises receiving the out-of-band message through the secure tunnel.

5. The method of claim 1, wherein receiving the out-of-band message comprises receiving the out-of-band message through a control plane of the SDWAN.

6. The method of claim 1, further comprising:
creating a session with the secure tunnel for the sequence of packets;
and updating the secure tunnel with the thread identifier after receiving the out-of-band message.

7. The method of claim 1, further comprising encapsulating the packets of the sequence of packets in a wrapper that includes the flow identifier.

8. The method of claim 1, wherein sending the sequence of packets comprises reducing a header of subsequent packets of the sequence of packets by removing fields from the header of the subsequent packets to form reduced packets.

9. The method of claim 8, wherein removing fields comprises removing fields that are the same in the sequence of packets.

10. The method of claim 1, further comprising:
encapsulating a start packet of the first set of packets of the sequence of packets in a wrapper that includes the flow identifier, the header of the encapsulated start packet including fields that are removed from the header of the subsequent packets; and
sending the encapsulated start packet from the first hub to the second hub through the secure tunnel.

11. A method comprising:
receiving a first set of packets of a sequence of packets with a first flow identifier at a second hub from a first hub through a secure tunnel of a Software-Defined Wide Area Network (SDWAN), the sequence of packets having a destination address;
saving the first flow identifier and routing the first set of packets to the destination address;
assigning a second flow identifier to the sequence of packets;
detecting thread punts for the first set of packets;
sending an out-of-band message to the first hub from the second hub that includes the first flow identifier and a thread identifier for the sequence of packets in response to detecting the thread punts;
receiving a second set of packets of the sequence of packets with the first flow identifier and the thread identifier from the first hub; and
routing the second set of packets to the destination address using the thread identifier.

12. The method of claim 11, wherein the out-of-band message is an Internet Control Message Protocol (ICMP) message.

13. The method of claim 11, wherein sending the out-of-band message comprises sending the out-of-band message through the secure tunnel.

14. The method of claim 11, wherein sending the out-of-band message comprises sending the out-of-band message through a control plane of the SDWAN.

15. The method of claim 11, further comprising assigning the first set of packets to a service processing thread and associating the thread identifier with the service processing thread.

16. The method of claim 11, wherein detecting thread punts comprises detecting that a packet of the first set of packets has landed on a wrong thread; using the first flow identifier to look up the service processing thread; and directing the packet to the service processing thread.

17. The method of claim 11, wherein detecting thread punts comprises detecting that a number of thread punts of the first set of packets exceeds a punt threshold.

18. The method of claim 11, wherein sending the out-of-band message comprises repeating sending the out-of-band message until a packet of the second set of packets is received.

19. The method of claim 18, wherein repeating sending the out-of-band message comprises sending the out-of-band message at non-deterministic intervals.

20. A non-transitory computer-readable storage medium containing program instructions, which when executed by the computer cause the computer to perform operations comprising:
receiving a first set of packets of a sequence of packets with a first flow identifier at a second hub from a first hub through a secure tunnel of a Software-Defined Wide Area Network (SDWAN), the sequence of packets having a destination address;
saving the first flow identifier and routing the first set of packets to the destination address;
assigning a second flow identifier to the sequence of packets;
detecting thread punts for the first set of packets;
sending an out-of-band message to the first hub from the second hub that includes the first flow identifier and a thread identifier for the sequence of packets in response to detecting the thread punts;
receiving a second set of packets of the sequence of packets with the first flow identifier and the thread identifier from the first hub; and
routing the second set of packets to the destination address using the thread identifier.
